(19) United States
(12) Patent Application Publication
(10) Pub. No.: US 2006/0020648 A1
(43) Pub. Date: Jan. 26, 2006

(54) Method for secure generation of a random number in a gaming system

(75) Inventors: Bruce Merati, San Diego, CA (US); Robert A. Nance, Solana Beach, CA (US)

Correspondence Address: HOGAN & HARTSON L.L.P., 500 S. GRAND AVENUE, SUITE 1900, LOS ANGELES, CA, 90071-2611, US

(73) Assignee: VirtGame Corp.

(21) Appl. No.: 11/159,661

(22) Filed: Jun. 23, 2005

Related U.S. Application Data
(60) Provisional application No. 60/585,176, filed on Jul. 1, 2004.

(51) Int. Cl. G06F 1/02

(52) U.S. Cl. 708/250

(57) ABSTRACT

A method for secure generation of a random number. An RNG sequence is generated using an RNG algorithm and an RNG seed. The current position within the RNG sequence is advanced every specified time interval. At intermittent intervals, the current position within the RNG sequence is advanced by a random amount.

### CROSS-REFERENCE TO RELATED APPLICATIONS

This application claims the benefit of U.S. provisional application No. 60/585,176, filed Jul. 1, 2004, which is hereby incorporated herein by reference.

### FIELD OF THE INVENTION

The present invention relates to electronic gaming devices and, in particular, relates to generation of random numbers (RNG) in a secure server-based gaming environment.

### BACKGROUND OF THE INVENTION

Gaming and wagering activities are typically tightly controlled and regulated by authorities such as state or county gaming boards or commissions, etc. Players making wagers on games of chance expect outcomes to be completely random and free from any tampering or unfair influence. A random number generator (RNG) is a special program, embodied in hardware, software, or combination of hardware and software, that uses an algorithm to generate number values that exhibit characteristics of randomness. Typically, each electronic gaming device in a casino will have an RNG chip or program embodied therein. As long as there is power to the device, the RNG is constantly generating a flow of random numbers. The RNG may have values ranging in the billions, which are then translated into a game outcome, whether that be a card in a game of blackjack or a symbol on the reel of a slot machine. At the very instant that a coin is inserted or a slot handle is pulled, the RNG generated at that instant is selected and is used to determine the game outcome.

Although RNGs have proven to be useful and reliable in games of chance, it is advantageous to enhance the level of randomness and uncertainty provided by RNGs operating within gaming systems.

### SUMMARY OF THE INVENTION

One embodiment of the invention is a method for secure generation of a random number. The method comprises generating an RNG sequence using an RNG algorithm and an RNG seed. The current position within the RNG sequence is advanced every specified time interval. At intermittent intervals, the current position within the RNG sequence is advanced by a random amount.

Another embodiment of the invention is a secure gaming system. The system comprises a plurality of client monitors that display gaming activity and accept user input but do not contain any gaming intelligence or perform any gaming processing. A game server coupled to the client monitors receives the user input from the client monitors, processes the input according to a game selected by the user and a current output of an RNG, and returns a game outcome response to the client monitors. A plurality of separate RNGs corresponding to the plurality of client monitors are stored on the game server.

Other systems, methods, features and advantages of the invention will be or will become apparent to one with skill in the art upon examination of the following figures and detailed description. It is intended that all such additional systems, methods, features and advantages be included within the description, be within the scope of the invention and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating a system according to the present invention.

FIG. 2 depicts advancement of the position within an RNG sequence according to the present invention.

### DETAILED DESCRIPTION OF THE INVENTION

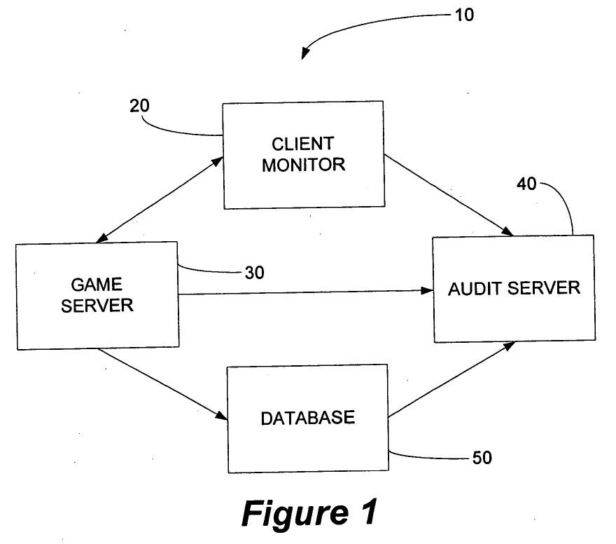

A secure server-based gaming platform or system 10 is illustrated in FIG. 1. System 10 includes a plurality of client monitors 20 (one shown), a game server 30, an audit server 40 and a database 50.

At least one client monitor 20, and typically a plurality of client monitors 20, is connected to a central game server 30. In one embodiment, client monitors 20 are dispersed throughout a casino gaming area and connected to a game server 30, which is located in a secure location accessible only to authorized personnel. Client monitors 20 may be dispersed, for example, in a manner similar to the placement of slot machines, video poker and other gaming stations throughout a casino.

Each client monitor 20 is a generic “dumb” terminal and makes no gaming decisions, calculations or actions. Instead, all gaming decisions, calculations and actions are made or taken by game server 30. The gaming software is stored and run on game server 30, while client monitors 20 simply display the on-going visual and audio aspects of the games to a player, and accepts input from the player in the form of gaming choices or decisions. Client monitors 20, via game server 30, may present any desired game or contest of skill or chance to players.

Typical casino games that may be presented by client monitor 20 (via game server 30) may include, for example, slots, poker, blackjack and other card games, roulette, craps, baccarat and so on. One of the advantages of the present invention is that the particular game presented by a client monitor 20 may be changed simply by provision of a new game by game server 30 to client monitor 20. There is no requirement that a physical change or replacement be made to the client monitor 20, as is the case with independent slot machines, for example. In one embodiment, a player may be presented with a plurality of game choices. That is, a player may choose to play blackjack, slots, poker or any other game from a single client monitor by making an appropriate choice of game. Once the player makes his choice of game, that input is provided to game server 30, which then runs the corresponding game software and provides the appropriate audio and video data to client monitor 20.

Typically, a player will place bets or wagers on the game being played, resulting in winnings or losses depending on the outcome of the game. As such, client monitors 20 also include appropriate hardware for accepting and dispersing funds to players. Client monitor 20 may include, for example, a slot for accepting coins, chips or tokens, a bill acceptor, a card reader or any other mechanism for accepting funds from a player. Client monitor 20 may also include means for physically (i.e coin/token/ticket/bill dispensers) or electronically transmitting funds to players. Client monitor 20 may also have an appropriate reader or interface permitting presentation of a players' club card or the like, containing personal information about the player and permitting game server 30 to track players' performance and play.

Client monitor 20 monitors all gaming actions and forwards those actions to game server 30 and audit server 40. Monitor 20 will typically include a display of some sort to display gaming activity and events, fund balances, etc., to the user. The display may be a cathode ray tube (CRT), liquid crystal display (LCD) or any other appropriate means for display. Monitor 20 also preferably includes speakers for gaming audio. Monitor 20 also includes some form of user interface to allow the user to provide input to system 10. The user interface may include, without limitation, buttons or keys, sensors, touch sensitive screens, cursor control devices such as a mouse, joysticks and so on. Monitor 20 may also include other components such as a printer for providing printouts of gaming activity, fund levels, etc.

In one implementation, monitor 20 utilizes a browser to display the content of game server 30. In one implementation, monitor 20 also comprises a proxy server for relaying user input to game server 30, receiving responses from game server 30, and reflecting or mirroring those response to audit server 40 (as will be described in more detail below).

Again, and importantly, no decisions, game processing or actions take place at client monitor 20. Client monitor 20 simply accepts input from players, relays that input to game server 30. Game server 30 receives the input from client monitor 20, provides the input to the processor running the gaming software, and transmits the result (i.e., the outcome of the game and wager) to client monitor 20. Client monitor 20 then displays the game and wager outcome to the player. This is extremely important from a security and regulation perspective. Gaming and wagering activities are typically tightly controlled and regulated by authorities such as state or county gaming boards or commissions, etc. As such, casino and gaming operators must show that games are not susceptible to manipulation or tampering by players or other persons. Removal of all game processing and game software from client monitor 20, and placement of all processing and decision activity in a central, secure and inaccessible gaming server, provides a very high level of protection against any manipulation or tampering of game processes and outcomes.

All gaming software resides on game server 30, and all gaming decisions and processing are made at game server 30. Game server 30 is securely linked to each client monitor 20 under its control, receives gaming input and request from those monitors, and provides the correct output or result to the client monitors in response. Game server 30 includes appropriate hardware and software for running various games of chance as described above.

Game server 30 may take various forms, such as a mainframe computer, a personal computer or workstation, a laptop computer and so on. Game server 30 will typically include a processor that controls operation of server 30, and calculates gaming outcomes based on input provided by client monitors 20. The processor may be any suitable central processing unit, general or special purpose microprocessor or digital signal processor. Server 30 will also include a memory coupled to the processor and containing the various game programs, as well as operational software for the server. The memory may comprise, for example, non-volatile memory devices such as, for example, EPROM (Erasable Programmable Read Only Memory), EEPROM (Electrically Erasable Programmable Read Only Memory), Flash memory, NVRAM (Non-Volatile Random Access Memory, internal and/or removable disks, CD-ROM or DVD-ROM disks, as well as volatile memory devices such as RAM or DRAM. Server 30 will also include appropriate displays and user interfaces to facilitate operation by authorized personnel.

Constant and Random Advancement of RNG

Game server 30 also hosts a separate and continuously running random number generator (RNG) for each client monitor 20 that server 30 is associated with. The random number generator (RNG) is a special program, embodied in hardware, software, or combination of hardware and software, that uses an algorithm to generate number values that exhibit characteristics of randomness. Since each client monitor 20 has its own independent RNG running on game server 30, the outcome of each client monitor 20 is in no way related to the outcomes of other client monitors.

In one implementation, the MRG63K3A algorithm is used. However, the principles of the present invention are applicable to any RNG algorithm. Each RNG for each client monitor is constantly generating a flow of random numbers. The RNG may have values ranging in the billions, which are then translated into a game outcome, whether that be a card in a game of blackjack or a symbol on the reel of a slot machine. At the very instant that a game choice or input is made by a player on the client monitor, the RNG generated at that instant is selected and is used to determine the game outcome. In one implementation, at that time, the RNG is “re-seeded” and a new sequence of random numbers is generated and constantly moved forward.

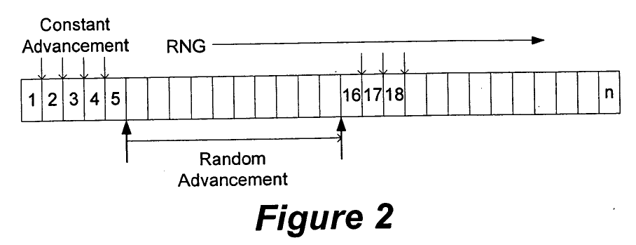

The present invention provides another level of randomness to the advancement of the RNG stream during periods of inactivity. Game server 30, during periods of inactivity, implements a low priority thread wherein it is constantly (or once every specified, extremely small, time interval) selecting the next random number in the current RNG sequence of numbers. This is illustrated in FIG. 2, which depicts in simplistic form an RNG sequence 1, 2, 3 . . . n generated from a particular seed of an RNG algorithm. As illustrated, one thread or routine of game server 30 constantly selects the next number in the RNG sequence. If the RNG sequence is thought of as slots, for instance, a pointer to a slot corresponding to the current position in the RNG sequence is moved forward sequentially from 1 to 2 to 3, etc. Each of these slots contains a random number that, if a game player were to take action at that time (i.e., pull a slot handle), the random number in that slot would be selected and used as the basis for generating the game outcome.

In addition to the constant advancement in the RNG sequence, an intermittent, higher priority thread moves the RNG sequence forward a random amount. This random amount is itself generated using an RNG program. Hence, as depicted in FIG. 2, after a period of constant and sequential advancement, from slots 1 to 5, the current position in the RNG sequence is then moved forward a random amount. In this case, the current position in the RNG sequence is arbitrarily moved forward from 5 to 16. After the random advancement, the RNG returns to a state of constant advancement (i.e. 16 to 17 to 18, etc.), until the next intermittent random advancement occurs. Hence, under the present invention, even if one were to gain knowledge of the RNG seed, and hence the RNG sequence, as well as the specific time that a machine was turned on, the current position within the RNG sequence still could not be known or predicted with a reasonable level of certainty due to the intermittent and random advancement within the RNG sequence.

In one implementation, to provide even greater unpredictability, the timing of the occurrence of the intermittent random advancement may itself be random. Hence, a random advancement may occur after 1 ms, and then not again until after 10 ms, and then again after 3 ms, etc.

All gaming events, outcomes, user decisions and inputs are provided to and logged by database 50. Audit server 40 provides real-time auditing of game play by double-checking and re-playing all games played. User input and actions, as well as the RNG seed, are provided to audit server 40 by game server 30. Audit server 40 uses this information to verify the random numbers generated by server 30, plays the games and compares the results with the log stored in database 50 to ensure that the outcome is what it should be. Client monitor 20 also mirrors the game outcomes returned to it by game server 30 to audit server 40, so that audit server 40 can verify that the proper outcomes are, in fact, being returned by game server 30 to client monitor 20.

Game server 30 and audit server 40 constantly monitor system integrity using appropriate monitoring and change detection software. There is a constant monitoring of, for example, registry settings, hardware configuration parameters, system files, directories, data files, file attributes and the like to ensure that the gaming platform is not modified or tampered with by anyone not having authorized access to the system. Any unauthorized access, changes, intrusions, corruptions, installations, removal or revisions to software, and so on, are instantly detected and notified. In one implementation, INTACT™ software from Pedestal Software, Inc. is deployed in game server 30 and audit server 40 to monitor system integrity.

Game server 30 constantly monitors system parameters and integrity of audit server 40 and client monitors 20. Audit server 40, in turn, constantly monitors the integrity of game server 30 and client monitors 20. Hence, each of the servers is constantly watching the other server, as well as the client monitors. This provides an extremely high level of security and ensures that any compromises of system integrity will be instantly detected.

Another aspect of the invention, as previously mentioned, is a real-time, remote event system that allows for notification of all events originating on client monitors 20 to game server 30. All processing intelligence is thereby removed from client monitors 20 and centralized in game server 30.

Another level of system security and integrity is provided by the use of “heartbeats” between system components. A heartbeat is a periodic signal sent by components of system 10 to signify that they are still active and reliable. A lack of a heartbeat within the specified interval (i.e. once a second, or whatever the interval is specified to be) signals that some form of failure or corruption of the device that failed to send the heartbeat. Hence, game server 30 and audit server 40 exchange heartbeats. If one is take over or corrupted in some way, the other will instantly know. Game server 30 and client monitors 20 exchange heartbeats. If game server 30 becomes unreliable, client monitors 20 will instantly know. If any of client monitors 20 is taken over or off line, game server 30 will instantly know. Client monitors 20 also provide a heartbeat to audit server 40, allowing audit server 40 to be instantly informed of any failure on the part of any of client monitors 20.

While various embodiments of the invention have been described, it will be apparent to those of ordinary skill in the art that many more embodiments and implementations are possible that are within the scope of this invention.

1. A method for secure generation of a random number in a gaming system comprising:
generating an RNG sequence using an RNG algorithm and an RNG seed;
advancing the current position within the RNG sequence every specified time interval;
at intermittent intervals, advancing the current position with the RNG sequence by a random amount.

2. A method as claimed in claim 1, and further comprising:
upon action triggering the selection of a random number at the current position with the RNG sequence, generating a new RNG sequence using the RNG algorithm and a new RNG seed.

3. A secure gaming system comprising:
a plurality of client monitors that display gaming activity and accept user input but do not contain any gaming intelligence or perform any gaming processing;
a game server coupled to the client monitors that receives the user input from the client monitors, processes the input according to a game selected by the user and a current output of an RNG, and returns a game outcome response to the client monitors, wherein
a plurality of separate RNGs corresponding to the plurality of client monitors are stored on the game server.

4. A system as claimed in claim 3, wherein the current output of the RNG is determined by constant advancement of the current position in an RNG sequence, and intermittent random advancements of the current position in the RNG sequence.
